(19) United States
(12) Patent Application Publication
(10) Pub. No.: US 2009/0043987 A1
(43) Pub. Date: Feb. 12, 2009

(54) Operation distribution method and system using buffer

(75) Inventors: Joon-ho Song, Hwaseong-si (KR); Si-hwa Lee, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/984,992

(22) Filed: Nov. 26, 2007

(30) Foreign Application Priority Data
Aug. 6, 2007 (KR) 10-2007-0078668

(51) Int. Cl. G06F 9/30; G06F 15/76

(52) U.S. Cl. 712/30; 712/220; 712/E09.016

(57) ABSTRACT

Provided is an operation distribution method and system using a buffer. The operation distribution system includes a buffer, a first operation device performing a first operation and storing a result of the first operation performed by the first operation device in the buffer, and a second operation device performing a second operation using the result of the first operation stored in the buffer, thereby reducing the time required to perform operations.

### CROSS-REFERENCE TO RELATED PATENT APPLICATION

This application claims the benefit of Korean Patent Application No. 10-2007-0078668, filed on Aug. 6, 2007, in the Korean Intellectual Property Office, the disclosure of which is incorporated herein in its entirety by reference.

### BACKGROUND OF THE INVENTION

1. Field of the Invention

The present invention generally relates to an operation distribution method and system in order to minimize the waiting time of each of a plurality of operation devices that perform operations, and more particularly, to an operation distribution method and system using a first-in first-out (FIFO) buffer.

2. Description of the Related Art

Conventionally, when a plurality of operation devices are used to process a large amount of data, operations to be processed have to be distributed to the operation devices. A data flow graph (DFG) technique is one of operation distribution techniques. The DFG technique involves expressing separate operations in the form of a graph according to dependency and temporal relationships between the operations. Each node of the graph indicates a separate operation, and an arrow between nodes indicates data dependency in which the result of an operation is input to another operation.

An operation distribution method using the DFG technique will now be described with reference to FIGS. 1A and 1B.

FIGS. 1A and 1B illustrate a conventional operation distribution method using the DFG technique.

Referring to FIG. 1A, A, B, C, and D indicate predetermined operation modules that perform operations independently. These four operation modules may operate in a cycle. In other words, the operation module A performs an operation the moment the operation module D performs an operation, the operation result of the operation module A is input to the operation module B and the operation module C, and such an operation process is repeated as will be described in detail with reference to FIG. 2.

For example, if the four operation modules A, B, C, and D operate in a cycle, each time they operate in a cycle, the time required for each of the operation modules to perform an operation may be as follows.

TABLE 1

| Operation | Repetition Number | | | | | | |
|---|---|---|---|---|---|---|---|
| Module | 1 | 2 | 3 | 4 | 5 | 6 | Average |
| A | 5 | 5 | 5 | 5 | 5 | 5 | 5 |
| B | 10 | 10 | 5 | 60 | 75 | 75 | 40 |
| C | 20 | 20 | 15 | 50 | 55 | 50 | 35 |
| D | 5 | 5 | 5 | 5 | 5 | 5 | 5 |

Referring to Table 1, when the operation modules A, B, C, and D repeat an operation process according to FIG. 1A 6 times, they consume 5, 40, 35, and 5 seconds on the average, respectively in order to perform operations. As a result, when the operation modules A, B, C, and D are arranged sequentially, an operation time of 85 (5+40+35+5) may be consumed. In this case, the operation modules B, C, and D wait for completion of an operation by the operation module A, increasing the average operation time. When the operation modules A, B, C, and D are arranged as illustrated in FIG. 1A and the operation time consumed by each of them is fixed to the average time provided in Table 1, the operation process according to FIG. 1A can be performed with an average operation time of 50. Since the operation module A and the operation module B are independent of each other in terms of a point of time at which operations are performed and the operation module B and the operation module C are also independent of each other, a first operation device may include the operation modules A and D and a second operation device may include the operation modules B and C or the first operation device may include the operation modules A and C and the second operation device may include the operation modules B and D.

Referring to FIG. 1B, when the operation module A performs an operation during a time of 5, the operation modules B, C, and D wait. When the operation module B performs an operation, the operation module C also performs an operation in parallel with the operation module B, thereby reducing the total operation time consumed by the operation modules A, B, C, and D. The total operation time is affected by the time consumed by one of the operation module B and the operation module C, which consumes greater time than with the other.

FIG. 2 illustrates the time consumed by the operation modules A, B, C, and D arranged as illustrated in FIG. 1A over time when they repeat an operation process 6 times. Let a device including the operation module A and the operation module B be a first operation device and a device including the operation module C and the operation module D be a second operation device. A dashed portion indicates the waiting time of each of the first and second operation devices. As can be seen in FIG. 2, when the operation time of the operation module B and the operation time of the operation module C are much different from each other like B3 and C3, the waiting time of one of the first and second operation devices increases. In other words, since the average operation time of each of the operation modules A, B, C, and D is calculated as a specific value and the DFG technique is applied based on the calculated average operation time, a change in the operation time over time may not be reflected, introducing a large amount of waiting time as illustrated in FIG. 2. As a result, although the conventional operation distribution method using the DFG technique is efficient when each of the operation modules has specific operation time, it cannot reflect a change in the operation time of any one of the operation modules over time when the operation modules have different operation times as in video encoding/decoding. Moreover, when operations are distributed to a plurality of operation devices to perform the operations, an operation device that finishes an operation early has to wait until other operation devices complete operations, increasing the total operation time.

### SUMMARY OF THE INVENTION

The present invention provides an operation distribution method and system using a first-in first-out (FIFO) buffer, in which the FIFO buffer is disposed between a first operation device and a second operation device, the first operation device stores an operation result in the FIFO buffer until it finishes performing an operation, and the second operation device reads a required operation result from the FIFO buffer in order to use the operation result of the first operation device, thereby minimizing the waiting time of each of the first operation device and the second operation device and thus improving the performance of an overall system.

According to one aspect of the present invention, there is provided an operation distribution system including a buffer, a first operation device performing a first operation and storing a result of the first operation performed by the first operation device in the buffer, and a second operation device performing a second operation using the result of the first operation stored in the buffer.

According to another aspect of the present invention, there is provided an operation distribution method including performing a first operation and storing a result of the first operation in a buffer, and if it is determined that the result of the first operation, which is stored in the buffer, is used, performing a third operation and storing a result of the third operation in the buffer.

According to another aspect of the present invention, there is provided an operation distribution method including performing a second operation using a result of an operation stored in a buffer, and if a result of another operation is stored in the buffer, performing a fourth operation using the stored result.

According to another aspect of the present invention, there is provided a computer-readable recording medium having recorded thereon a program for executing the operation distribution method.

### BRIEF DESCRIPTION OF THE DRAWINGS

The above and other features and advantages of the present invention will become more apparent by describing in detail an exemplary embodiment thereof with reference to the attached drawings in which:

FIGS. 1A and 1B illustrate a conventional operation distribution method using a data flow graph (DFG) technique;

FIG. 2 illustrates the time consumed by operation modules arranged as illustrated in FIG. 1A over time when they repeat an operation process 6 times;

FIG. 3 illustrates an operation distribution system using a buffer according to an exemplary embodiment of the present invention;

FIG. 4 illustrates a first-in first-out (FIFO) buffer used in the operation distribution system according to an exemplary embodiment of the present invention;

FIG. 5 is a flowchart illustrating a process by a first operation device of the operation distribution system according to an exemplary embodiment of the present invention;

FIG. 6 is a flowchart illustrating a process by a second operation device of the operation distribution system according to an exemplary embodiment of the present invention;

FIG. 7 illustrates the time consumed by the operation modules arranged as illustrated in FIG. 1A over time when they repeat an operation process 6 times using an operation distribution method according to an exemplary embodiment of the present invention;

FIG. 8 is a block diagram of a video decoding apparatus using 3 operation devices and 3 buffering units illustrated in FIG. 3; and

FIG. 9 is a block diagram of a video decoding apparatus using 5 operation devices and 4 buffering units illustrated in FIG. 3.

### DETAILED DESCRIPTION OF THE INVENTION

Hereinafter, an exemplary embodiment of the present invention will be described in detail with reference to the accompanying drawings. It should be noted that like reference numerals refer to like elements illustrated in one or more of the drawings. In the following description of the present invention, detailed description of known functions and configurations incorporated herein will be omitted for conciseness and clarity.

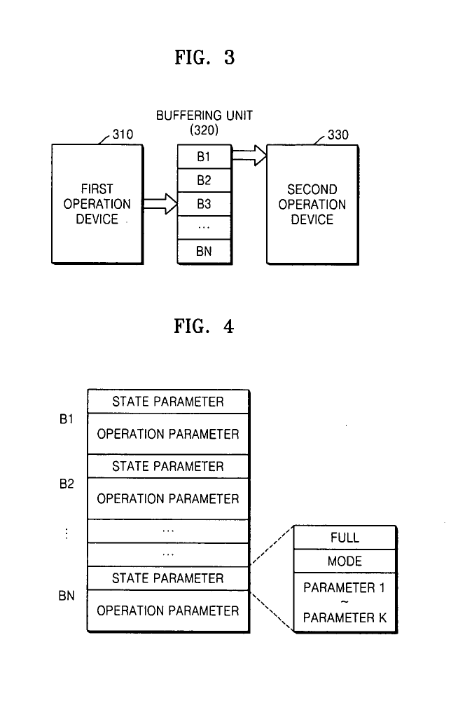

FIG. 3 illustrates an operation distribution system using a buffer according to an exemplary embodiment of the present invention.

Referring to FIG. 3, the operation distribution system includes a first operation device 310, a buffering unit 320, and a second operation device 330. Each of the first operation device 310 and the second operation device 330 may include a central processing unit (CPU), a digital signal processor (DSP), and a hardware accelerator.

Once the first operation device 310 starts to perform an operation, it outputs a drive signal for driving the second operation device 330 to the second operation device 330. When the first operation device 310 completes its assigned operations, it sends a complete signal indicating completion of the assigned operations to the second operation device 330. When a parameter OP2_active shared between the first operation device 310 and the second operation device 320 is set to 0, it serves as the complete signal. When the parameter OP2_active is set to 1, it serves as the drive signal. The drive signal causes the second operation device 330 to read a full parameter indicating that an operation result is stored in a first buffer of the buffering unit 320. By the drive signal sent by the first operation device 310 to the second operation device 330, the second operation device 330 can access the first buffer of the buffering unit 320 and read the full parameter.

The first operation device 310 stores results of its assigned operations from among a plurality of operations required by the operation distribution system for data processing in the buffering unit 320 in the order in which the operations are performed. Once the first operation device 310 completes its assigned operations, it sends the complete signal indicating completion of the assigned operations to the second operation device 320. The complete signal indicates that the first operation device 310 completes its assigned operations. By the complete signal sent by the first operation device 310 to the second operation device 330, the second operation device 330 can determine whether the first operation device 310 completes its assigned operations.

The first operation device 310 stores its operations results in an operation parameter region of the buffering unit 320 and stores state information of the buffering unit 320 in a state parameter region of the buffering unit 320. The state information includes a full parameter indicating whether the operation result is stored in the buffering unit 320 and a mode parameter indicating the data size of the stored operation result. When the buffering unit 320 is divided into N unit buffers, the full parameter and the mode parameter may exist for each of the unit buffers. Herein, N is a natural number. Thus, the first operation device 310 stores the operations result in an operation parameter region of a unit buffer of the buffering unit 320 and stores state information of the unit buffer in a state parameter region of the unit buffer. State information indicating whether the operation result is stored in each of the unit buffers of the buffering unit 320 and indicating the data size of the stored operation result is stored in the state parameter. The operation results generated by the first operation device 310 are stored in the operation parameter. The second operation device 330 performs operations using the stored operation results.

The first operation device 310 divides a storage space of the buffering unit 320 for storing the operation results into N unit buffers and divides each of the unit buffers into the operation parameter region for storing the operation result of the first operation device 310 and the state parameter region for storing state information of the unit buffer. The second operation device 330 may use the operation results stored by the first operation device 310 in the buffering unit 320 based on the state information of the state parameter regions.

The first operation device 310 stores its operation results in the N unit buffers of the buffering unit 320 in the order in which the operation results are stored in order to allow the second operation device 330 to use the stored operation results in performing operations. To this end, the buffering unit 320 may be a first-in first-out (FIFO) buffer. When no unit buffer remains to store operation results, the first operation device 310 waits until the storage space of the unit buffer where the operation result is first stored becomes empty, and then stores the operation results in the empty storage space of the unit buffer.

When the buffering unit 320 is an FIFO buffer, the operation parameter and the state parameter exist for each of the N unit buffers. An operation result received from the first operation device 310 is stored in the operation parameter region and is output to the second operation device 320 at the request of the second operation device 320. The second operation device 320 uses operation results stored in the operation parameters regions based on state information stored in the state parameters regions. The first operation device 310 can store its operation results in the buffering unit 320 without determining whether the second operation device 320 completes operations. Each time the second operation device 320 requires the operation results stored by the first operation device 310 in the buffering unit 320, it can access the buffering unit 320 and reads the stored operation results from the buffering unit 320, thereby reducing the unnecessary waiting time of the first operation device 310 or the second operation device 330. Herein, the buffering unit 320 is the FIFO buffer composed of N unit buffers B1 through BN.

Once the second operation device 330 determines that the operation results generated by the first operation device 310 are stored in the unit buffers of the buffering unit 320 based on the state information of the state parameter regions the moment the first operation device 310 stores its operation results and state information in the operation parameter regions and the state parameter regions, respectively, the second operation device 330 performs operations using the operation results stored in the operation parameter regions of the unit buffers and then changes the state information of the state parameter regions of the unit buffers. The change of the state information is made such that the full parameter indicating whether the operation result of the first operation device 310 is stored indicates that the operation result is not stored.

The second operation device 330 performs operations using the operation results generated by the first operation device 310 stored in the buffering unit 320 until it receives a complete signal indicating that completion of the assigned operations from the first operation device 310 and determines that the first operation device 310 has no operation result to be further stored in the buffering unit 320.

The second operation device 330 receives the complete signal indicating that the first operation device 310 has completed its assigned operations from the first operation device 310. After the receipt, the second operation device 330 determines that it uses all operation results generated by the first operation device 310 stored in the buffering unit 320 if the second operation device 330 determines that there is no operation result to be further used based on state information stored in a unit buffer to be used by the second operation device 330.

FIG. 4 illustrates an FIFO buffer used in the operation distribution system according to an exemplary embodiment of the present invention.

The buffering unit 320 is a multi-buffer composed of N unit buffers, and is an FIFO buffer. Each of the unit buffers is composed of a state parameter region and an operation parameter region.

The state parameter region stores state information of the unit buffer. The state information includes a full parameter indicating whether an operation result is stored in the unit buffer and a mode parameter indicating the data size of the stored operation result.

The full parameter is set to 1 when the operation result is stored in the unit buffer, and is set to 0 when the operation result is not stored in the unit buffer.

The mode parameter also indicates the storage space size of the unit buffer. Using the mode parameter, data storage space size can be set uniform or variable according to the type of data stored in the N unit buffers. When the storage space size of a unit buffer is indicated by the mode parameter, each of the first operation device 310 and the second operation device 330 can calculate a buffer size corresponding to a mode. Thus, the mode parameter can be substituted by a size parameter for storing the storage space size of a unit buffer. Parameters 1 through K are reserved parameters for future needs of users.

The operation parameter region stores operation results generated by the first operation device 310. The second operation device 330 performs an operation using an operation result stored in the operation parameter region of each of the unit buffers.

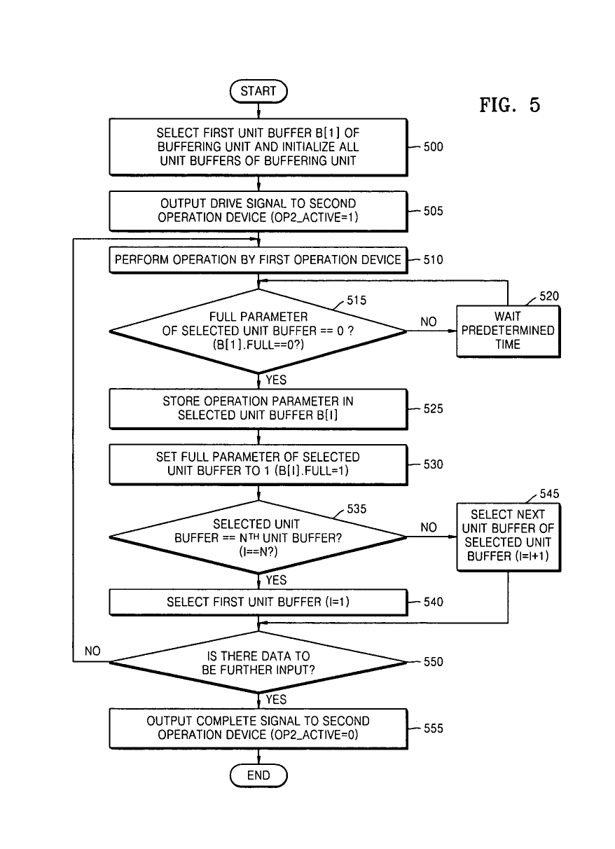

FIG. 5 is a flowchart illustrating a process by the first operation device 310 of the operation distribution system according to an exemplary embodiment of the present invention. Hereinafter, a process by the first operation device 310 will be described with reference to FIGS. 3 through 5.

In operation 500, the first operation device 310 selects the first unit buffer of the buffering unit 320 and initializes all unit buffers of the buffering unit 320. The unit buffer selected by the first operation device 310 is indicated by B[i]. By substituting 1 into an index i of B[i], the first operation device 310 can select the first unit buffer. Initialization of the buffering unit 320 means that the storage spaces of the unit buffers of the buffering unit 320 are emptied.

In operation 505, the first operation device 310 outputs a drive signal to the second operation device 330.

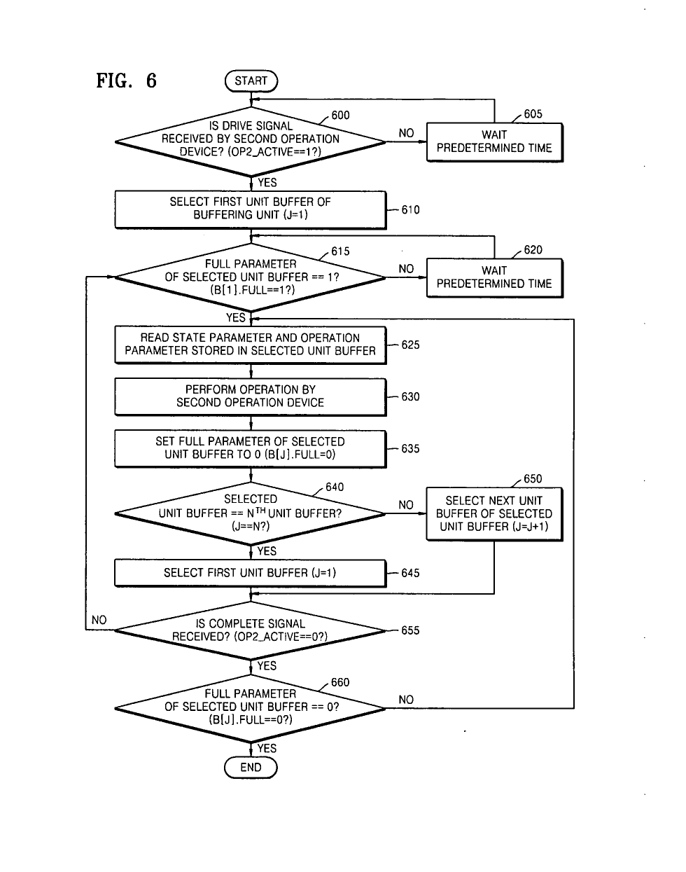

The drive signal causes the second operation device 330 to read a full parameter indicating that an operation result is stored from the first buffer of the buffering unit 320. By the drive signal sent by the first operation device 310 to the second operation device 330, the second operation device 330 can access the first buffer of the buffering unit 320 and read the full parameter. When the full parameter has a value of 1, the second operation device 330 starts to perform an operation. A parameter OP2_active set to 1 can serve as the drive signal. A process by the second operation device 330 will be described later in detail with reference to FIG. 6.

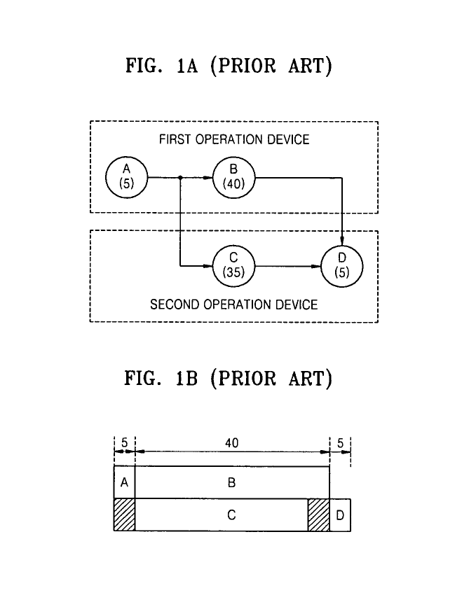

In operation 510, the first operation device 310 performs operations assigned by the operation distribution system and generates state parameters and operation parameters as operation results. Referring to FIG. 1A, if the first operation device 310 includes operation modules A and B, the first operation device 310 has to sequentially repeat the operation modules A and B 6 times, and the first execution of the operation module A is A1, operations are executed sequentially in the order of A1->B1->A2->B2->A3->B3->A4->B4->A5->B5->A6->B6 one by one each time operation 510 is performed. In other words, an operation performed by the first operation device 310 in operation 510 is one of the operations A1 through B6, and the first operation device 310 sequentially performs the operations A1 through B6 one by one each time operation 510 is performed.

In operation 515, the first operation device 310 determines whether a full parameter of a unit buffer is 0. A full parameter of an i^{th} unit buffer is indicated by B[i].Full. The unit buffer may be the first unit buffer selected in operation 500 or a unit buffer to be selected in operation 540 or 545. If the full parameter B[i].Full of the selected unit buffer is 0, it means that an operation parameter to be used by the second operation device 330 is not stored in the selected unit buffer. If the full parameter B[i].Full of the selected unit buffer is 1, it means that the operation parameter to be used by the second operation device 330 is stored in the selected unit buffer. If the full parameter is 0, the first operation device 310 goes to operation 525. If the full parameter is 1, the first operation device 310 goes to operation 520. Operation 515 is intended such that the first operation device 310 determines whether there remains a parameter storage space in the i^{th} unit buffer from the full parameter and waits until the second operation device 330 uses an operation parameter stored in the j^{th} unit buffer if there remains no parameter storage space in the i^{th} unit buffer.

In operation 520, the first operation device 310 waits a predetermined time. More specifically, the first operation device 310 waits until the second operation device 330 uses the operation parameter of the selected unit buffer B[i] determined in operation 515 and thus there is no operation parameter to be used by the second operation device 330 in the selected unit buffer. The predetermined time may be set at random by a user.

In operation 525, the first operation device 310 stores an operation parameter to be used by the second operation device 330 in the selected unit buffer B[i] determined in operation 515. The operation parameter is an operation result generated by the first operation device 310 in operation 510.

In operation 530, the first operation device 310 sets a full parameter of the selected unit buffer B[i] determined in operation 515 to 1. If the full parameter is 1, it means that data to be used by the second operation device 330 is stored in the unit buffer B[i]. By storing 1 in the full parameter B[i].Full of the i^{th} unit buffer, the first operation device 310 can perform operation 530.

In operation 535, the first operation device 310 determines whether the unit buffer B[i] determined in operation 515 is an N^{th} unit buffer B[N]. If the buffering unit 320 is composed of N unit buffers and the number of operation results to be stored is greater than N, the remaining operation results after storage of the N operation results in the N unit buffers of the buffering unit 320 have to be sequentially stored in the N unit buffers again from the first unit buffer. For this reason, the determination of operation 535 is required. Thus, the buffering unit 320 is an FIFO buffer. If the unit buffer B[i] is the N^{th} unit buffer B[N], the first operation device 310 goes to operation 540. If the unit buffer B[i] is not the N^{th} unit buffer B[N], the first operation device 310 goes to operation 545.

In operation 540, the first operation device 310 selects the first unit buffer B[1].

In operation 545, the first operation device 310 selects a next unit buffer B[i+1] of the unit buffer B[i] determined in operation 515.

In operation 550, the first operation device 310 determines whether there remains input data assigned by the operation distribution system. If so, the first operation device 310 goes to operation 510. If not, the first operation device 310 goes to operation 555.

In operation 555, the first operation device 310 outputs a complete signal to the second operation device 330. The complete signal informs the second operation device 330 that the first operation device 310 has completed assigned operations. The first operation device 310 sets the parameter OP2_active to 0 and outputs the parameter OP2_active of 0 to the second operation device 330, thereby outputting the complete signal to the second operation device 330. Upon receipt of the complete signal, the second operation device 330 can confirm that operation results generated by the first operation device 310, which are to be used by the second operation device 330, have been stored in the buffering unit 320. When the second operation device 330 receives the complete signal and there is no operation result stored in the buffering unit 320, it can be determined that all operations of the operation distribution system have been completed. In other words, when the parameter OP2_active is set to 0, the second operation device 330 can be informed that the first operation device 310 inputs all operation results to the buffering unit 320.

FIG. 6 is a flowchart illustrating a process by the second operation device 330 of the operation distribution system according to an exemplary embodiment of the present invention. Hereinafter, a process by the first operation device 330 will be described with reference to FIGS. 3 through 5.

In operation 600, the second operation device 330 determines whether it receives a drive signal from the first operation device 310. The drive signal means that the first operation device 310 starts to perform an operation. Upon receipt of the drive signal, the second operation device 330 starts to perform an operation. If it is determined that the drive signal is received, the second operation device 330 goes to operation 610. If it is determined that the drive signal is not received, the second operation device 330 goes to operation 605. The first operation device 310 sets a parameter OP2_active for controlling operation execution of the second operation device 330 to 1 and outputs the parameter OP2_active of 1 to the second operation device 330. Thus, the parameter OP2_active of 1 serves as the drive signal. In operation 600, the second operation device 330 determines whether the parameter OP2_active is 1, thereby determining whether the drive signal is received from the first operation device 310.

In operation 605, the second operation device 330 waits a predetermined time. Since the second operation device 330 uses an operation result of the first operation device 310, it does not need to perform an unnecessary operation until the first operation device 310 starts an operation. Thus, the second operation device 330 maintains power a predetermined time to the extent that it can receive the drive signal and output a control signal for driving the second operation device 330 based on the received drive signal. The predetermined time may be set by the user.

In operation 610, the second operation device 330 selects the first unit buffer B[j] of the buffering unit 320. j is a natural number from 1 to N, and N is the number of unit buffers included in the buffering unit 320.

In operation 615, the second operation device 330 determines whether a full parameter B[j].Full of a unit buffer selected in one of operations 610, 645, and 650 is 1. Referring to FIG. 5, if the full parameter B[j].Full of the selected unit buffer is 1, it means that data to be used by the second operation device 330 is stored in the selected unit buffer and thus there remains no storage space in the selected unit buffer. If it is determined that the full parameter B[j].Full is 1, the second operation device 330 goes to operation 625. If it is determined that the full parameter B[j]. Full is 0, the second operation device 330 goes to operation 620. If it is determined that an operation parameter to be used by the second operation device 330 is not stored in a j^{th} unit buffer, the second operation device 330 has to wait until the first operation device 310 stores the operation parameter in the j^{th} unit buffer. For this reason, the determination of operation 615 is required.

In operation 620, the second operation device 330 waits a predetermined time. Since the second operation device 330 uses an operation result of the first operation device 310, it has to wait until the first operation device 310 performs an operation and inputs its operation result to a unit buffer of the buffering unit 320. The predetermined time can be set by a user.

In operation 625, the second operation device 330 reads a state parameter and an operation parameter stored in the unit buffer B[j] determined in operation 615. Referring to FIG. 5, the operation parameter and the state parameter are operation results generated by the first operation device 310 in operation 510.

In operation 630, the second operation device 330 performs an operation assigned by the operation distribution system using the state parameter and the operation parameter read in operation 625. Referring to FIG. 1A, if the second operation device 330 includes the operation modules C and D, the second operation device 330 has to sequentially repeat the operation modules C and D 6 times, and the first execution of the operation module C is C1, operations are executed sequentially in the order of C1->D1->C2->D2->C3->D3->C4->D4->C5->D5->C6->D6 one by one each time operation 630 is performed. In other words, an operation performed by the first operation device 310 in operation 510 is one of the operations A1 through B6, and the first operation device 310 sequentially performs the operations A1 through B6 one by one each time operation 510 is performed. For example, in operation 630, the second operation device 330 may perform an operation assigned by the operation distribution system using the state parameter and the operation parameter stored in operation 625 in the j^{th} unit buffer B[j].

In operation 635, the second operation device 330 sets the full parameter B[j].Full stored in the unit buffer B[j] determined in operation 615 to 0. If the full parameter is 0, it means that data to be used by the second operation device 330 is not stored in the unit buffer B[j] determined in operation 615.

In operation 640, the second operation device 330 determines whether the unit buffer B[j] determined in operation 615 is an N^{th} unit buffer B[N]. If the unit buffer B[j] determined in operation 615 is the N^{th} unit buffer B[N], the second operation device 330 goes to operation 645. If the unit buffer B[j] determined in operation 615 is not the N^{th} unit buffer B[N], the second operation device 330 goes to operation 650.

In operation 645, the second operation device 330 selects the first unit buffer B[j].

In operation 650, the second operation device 330 selects a next unit buffer B[j+1] of the unit buffer B[j] determined in operation 615.

In operation 655, the second operation device 330 determines whether it receives a complete signal from the first operation device 310. The complete signal informs the second operation device 330 that the first operation device 310 has completed its operations. By receiving the complete signal, the second operation device 330 can confirm that operation results of the first operation device 310 to be used by the second operation device 330 are stored in the storing unit 320. If it is determined that the complete signal is received, the second operation device 330 goes to operation 660. If not, the second operation device 330 goes to operation 615. The first operation device 310 sets the parameter OP2_active to 0 and outputs the parameter OP2_active of 0 to the second operation device 330, thereby outputting the complete signal to the second operation device 330. Thus, the second operation device 330 can determine whether the complete signal is received from the first operation device 310 by determining whether the parameter OP2_active is set to 0.

In operation 660, the second operation device 330 determines whether a full parameter B[j].Full of the unit buffer selected in one of operations 645 and 650 is 0. Referring to FIG. 5, if the full parameter is 0, it means that an operation parameter to be used by the second operation device 330 is not stored in the selected unit buffer. If the full parameter of the selected unit buffer is 0, it can be determined that all operations of the operation distribution system have been completed. However, of the full parameter of the selected unit buffer is 1, it means that there remains an operation result of the first operation device 310 in the buffering unit 320. In this case, the second operation device 330 goes to operation 625.

If the second operation device 330 receives the parameter OP2_active set to 0 in operations 655 and 660 and determines that the full parameter B[j].Full of the selected unit buffer is 0, it can be determined that all operations of the operation distribution system have been completed.

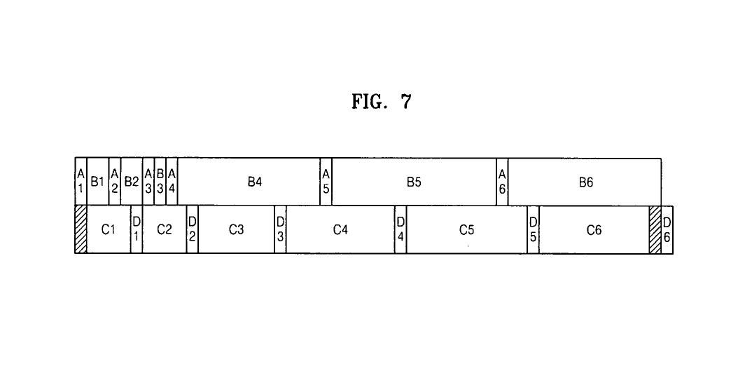

FIG. 7 illustrates the time consumed by the operation modules arranged as illustrated in FIG. 1A over time when they repeat an operation process 6 times using an operation distribution method according to an exemplary embodiment of the present invention.

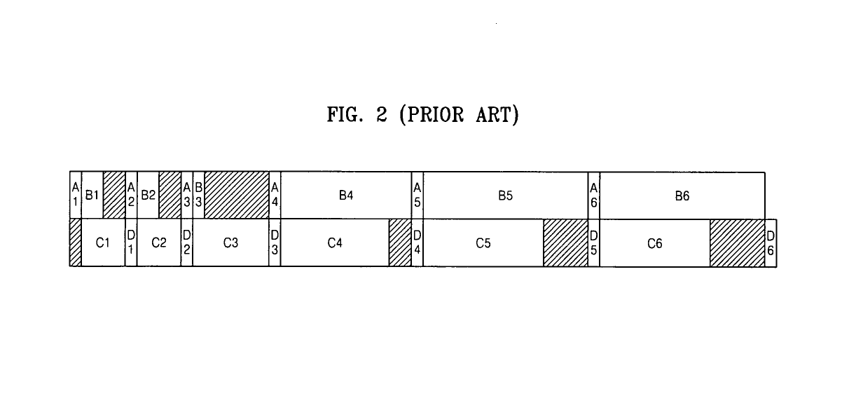

Let a device performing the operation modules A and B be a first operation device and a device performing the operation modules C and D be a second operation device. A dashed portion indicates the wait time of each of the first operation device and the second operation device. Referring to FIGS. 2 and 7, the first operation device performs an operation module B1 and then stores the operation result of the operation module B1 in a FIFO buffer without waiting completion of execution of an operation module C1. Thus, the first operation device performs an operation module A2 immediately after completion of execution of the operation module B1. As a result, the first operation device has no wait time during execution of operation modules A1 through B6. However, since the second operation device requires the operation result of the operation module A1 of the first operation device in order to perform the operation module C1, the second operation device waits the time during which the operation module A1 is performed. Since an operation module D6 of the second operation device requires the operation result of the operation module B6, the second operation device waits until completion of the execution of the operation module B6 even if the execution of an operation module C6 is completed.

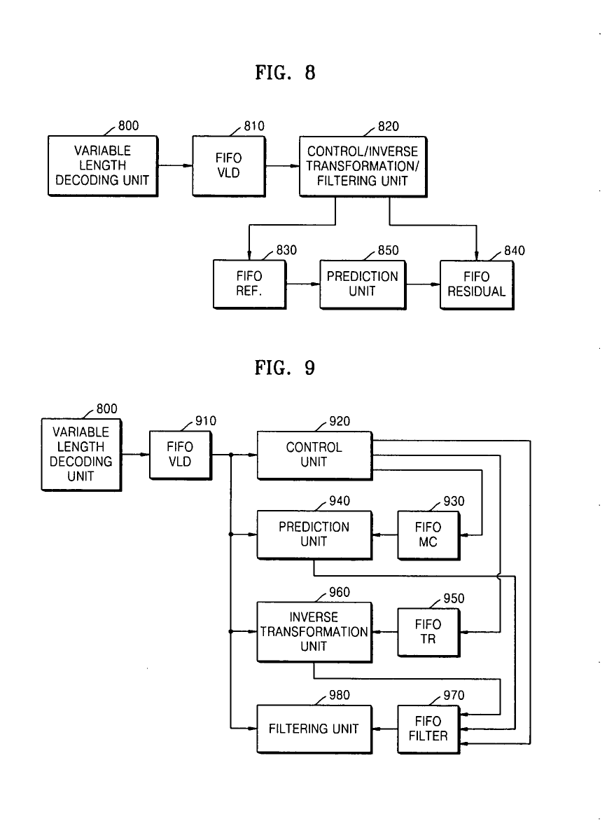

FIG. 8 is a block diagram of a video decoding apparatus using 3 operation devices and 3 buffering units illustrated in FIG. 3. In order to process a large amount of video data, it is more beneficial to use a plurality of operation devices and dedicated hardware than to use one operation device. In the implementation of a video encoding/decoding algorithm, an operation distribution method using a buffer according to the present invention to distribute the video encoding/decoding algorithm to operation modules and assign the operation modules to the operation devices according to the amount of computation of the operation modules will be described below.

Referring to FIG. 8, each of a variable length decoding unit 800, a control/inverse-transformation/filtering unit 820, and a prediction unit 850 corresponds to an operation device, and each of an FIFO Variable Length Decode (VLD) 810, an FIFO Reference (Ref) 830, and an FIFO Residual 840 corresponds to an FIFO buffer.

Referring to FIG. 3, the variable length decoding unit 800 corresponds to the first operation device 310, the control/inverse-transformation/filtering unit 820 corresponds to the second operation device 330, and the FIFO VLD 810 corresponds to the buffering unit 320. In relation to the control/inverse-transformation/filtering unit 820 and the prediction unit 850, the control/inverse-transformation/filtering unit 820 corresponds to the first operation device 310, the prediction unit 850 corresponds to the second operation device 330, and the FIFO Ref 830 and the FIFO Residual 840 correspond to the buffering unit 320.

Hereinafter, the operation of the video decoding apparatus will be described with reference to FIG. 8. Information decoded by the variable length decoding unit 800 is stored in the FIFO VLD 810, and the control/inverse-transformation/filtering unit 820 and the prediction unit 850 perform operations using the information stored in the FIFO VLD 810. The control/inverse-transformation/filtering unit 820 stores information used for prediction of the prediction unit 850 in the FIFO Ref 830 using the information stored in the FIFO VLD 810. The control/inverse-transformation/filtering unit 820 also performs inverse transformation using the information stored in the FIFO VLD 810 and then stores the operation result in the FIFO Residual 840. The prediction unit 850 combines prediction information that is the operation result using the information stored in the FIFO Ref 830 with the information stored in the FIFO Residual 840, thereby generating a reconstruction image. The control/inverse-transformation/filtering unit 820 can selectively filter the generated reconstruction image.

FIG. 9 is a block diagram of a video decoding apparatus using 5 operation devices and 4 buffering units illustrated in FIG. 3.

Referring to FIG. 9, each of a variable length decoding unit 900, a control unit 920, a prediction unit 940, an inverse transformation unit 960, and a filtering unit 980 corresponds to an operation device and each of an FIFO VLD 910, an FIFO Memory Control (MC) 930, an FIFO Transform (TR) 950, and an FIFO filter 970 corresponds to an FIFO buffer.

Referring to FIG. 3, the variable length decoding unit 900 corresponds to the first operation device 310, the control unit 920 corresponds to the second operation device 330, and the FIFO VLD 910 corresponds to the buffering unit 320. If the prediction unit 940 corresponds to the second operation device 330, the variable length decoding unit 900, the FIFO VLD 910, and the control unit 920 correspond to the first operation device 310 and the FIFO MC 930 corresponds to the buffering unit 320. When the inverse transformation unit 960 corresponds to the second operation device 330, the variable length decoding unit 900, the FIFO VLD 910, and the control unit 920 may correspond to the first operation device 310 and the FIFO TR 950 may correspond to the buffering unit 320. When the filtering unit 980 corresponds to the second operation device 330, the variable length decoding unit 900, the FIFO VLD 910, the control unit 920, the FIFO MC 930, the prediction unit 940, the FIFO TR 950, and the inverse transformation unit 960 may correspond to the first operation device 310 and the FIFO filter 970 may correspond to the buffering unit 320.

Hereinafter, the operation of the video decoding apparatus will be described with reference to FIG. 9. The variable length decoding unit 900 performs variable length decoding and stores the operation result in the FIFO VLD 910. The control unit 920 stores information for driving the prediction unit 940, the inverse transformation unit 960, and the filtering unit 980 in the FIFO MC 930, the FIFO TR 950, and the FIFO filter 970, respectively. The prediction unit 940 stores its prediction result in the FIFO filter 970. The inverse transformation unit 960 stores a prediction error generated by inverse transformation in the FIFO filter 970. The filtering unit 980 combines the prediction result and the prediction error that are stored in the FIFO filter 970, thereby generating a reconstruction image. Selectively, the filtering unit 980 may also perform filtering.

As described above, the operation distribution method and system using a buffer can be applied to video encoder/decoder, an image processor, or a multi-core.

Meanwhile, the embodiment of the present invention can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet). The computer readable recording medium can also be distributed over network coupled computer systems so that the computer readable code is stored and executed in a distributed fashion.

While the present invention has been particularly shown and described with reference to an exemplary embodiment thereof, it will be understood by those of ordinary skill in the art that various changes in form and detail may be made therein without departing from the spirit and scope of the present invention as defined by the following claims.

What is claimed is:

1. An operation distribution system comprising:
a buffer;
a first operation device performing a first operation and storing a result of the first operation performed by the first operation device in the buffer; and
a second operation device performing a second operation using the result of the first operation stored in the buffer.

2. The operation distribution system of claim 1, wherein if the result of the first operation is stored in the buffer, the first operation device stores a first value indicating that the result of the first operation is stored in the buffer, and the second operation device performs the second operation according to the first value stored in the buffer.

3. The operation distribution system of claim 2, wherein the buffer is a first-in first-out (FIFO) buffer including a plurality of unit buffers, and
each of the unit buffers includes a first field in which a result of an operation performed by the first operation device is stored and a second field in which a parameter indicating a state of the first field is stored, and
if the parameter indicating the state of the first field in which the result of the first operation is stored is the first value, the second operation device starts to perform the second operation.

4. The operation distribution system of claim 1, wherein if the second operation is completed, the second operation device stores a second value indicating completion of the second operation in the buffer, and
the first operation device performs a third operation and stores a result of the third operation in the buffer according to the second value stored in the buffer.

5. The operation distribution system of claim 4, wherein the buffer is an FIFO buffer including a plurality of unit buffers, and
each of the unit buffers includes a first field in which a result of an operation performed by the first operation device is stored and a second field in which a parameter indicating a state of the first field is stored, and
the first operation device performs the third operation, and if the parameter is the second value, the first operation device stores a result of the third operation in the buffer.

6. The operation distribution system of claim 1, wherein when the first operation device starts to perform the first operation, the first operation device sends a drive signal causing the second operation device to read a parameter indicating that the result of the first operation is stored in the buffer to the second operation device, and
if the drive signal is received, the second operation device starts to read the parameter indicating that the result of the first operation is stored in the buffer.

7. The operation distribution system of claim 1, wherein when the first operation device completes the first operation, the first operation device sends a complete signal indicating that the first operation device has completed the first operation to the second operation device, and
if the second operation device receives the complete signal and the result of the first operation is not stored in the buffer, the second operation device terminates the second operation.

8. The operation distribution system of claim 1, wherein the first operation and the second operation are some of operations for video decoding.

9. An operation distribution method comprising:
performing a first operation and storing a result of the first operation in a buffer; and
if it is determined that the result of the first operation, which is stored in the buffer, is used, performing a third operation and storing a result of the third operation in the buffer.

10. The operation distribution method of claim 9, wherein the storing of the result of the first operation comprises storing a first value indicating that the result of the first operation is stored in the buffer, and
the storing of the result of the third operation comprises performing the third operation if a second value indicating that the result of the first operation is used by an operation device is stored in the buffer and storing the result of the third operation in the buffer.

11. The operation distribution method of claim 9, wherein the buffer is a first-in first-out (FIFO) buffer including a plurality of unit buffers, and
each of the unit buffers includes a first field in which a result of one of a plurality of operations including the first operation is stored and a second field in which a parameter indicating a state of the first field is stored, and
the storing of the result of the first operation comprises, if the result of the first operation is stored in one of the unit buffers of the buffer, storing a first value for the parameter of the unit buffer, and
the storing of the result of the third operation comprises, if the parameter of the unit buffer is changed to a second value, performing the third operation and storing the result of the third operation in the unit buffer.

12. The operation distribution method of claim 9, further comprising:
when the first operation is started, sending a drive signal causing a parameter indicating that a result of an operation is stored in the buffer to be read to an operation device for distributing operations; and
when the first operation is completed, sending a complete signal indicating completion of an operation to the operation device.

13. An operation distribution method comprising:
performing a second operation using a result of an operation stored in a buffer; and
if a result of another operation is stored in the buffer, performing a fourth operation using the stored result.

14. The operation distribution method of 13, wherein the performing of the second operation comprises:
determining whether a first value indicating that a result of an operation is stored in the buffer is stored;
if the first value is stored, performing the second operation using the result of the operation stored in the buffer; and
storing a second value indicating that the result of the operation stored in the buffer is used.

15. The operation distribution method of claim 13, wherein the buffer is an FIFO buffer including a plurality of unit buffers, and
each of the unit buffers includes a first field in which a result of an operation performed by the first operation device is stored and a second field in which a parameter indicating a state of the first field is stored, and
the performing of the second operation comprises:
determining whether a parameter of one of the unit buffers of the buffering unit is the first value indicating that the result of the operation is stored;
if the parameter is the first value, performing the second operation using the result of the operation stored in the unit buffer; and
changing the parameter to the second value indicating that the result of the operation stored is used.

16. The operation distribution method of claim 13, further comprising:
if a drive signal causing the parameter indicating that the result of the operation is stored in the buffer to be read is received from an operation device for distributing operations, starting to read the parameter indicating that the result of the operation is stored in the buffer; and
if a complete signal indicating completion of an operation is received from the operation device and a result of an operation is not stored in the buffer, terminating the operation.

17. A computer-readable recording medium having recorded thereon a program for executing the operation distribution method of claim 9 or 13.
